(19) United States
(12) Patent Application Publication
(10) Pub. No.: US 2010/0310903 A1
(43) Pub. Date: Dec. 9, 2010

(54) Electrodeposition of hard to deposit materials on aluminum and other substrates using improved water saving mercy cell

(76) Inventor: Bassey J. Udofot, Knoxville, TN (US)

Correspondence Address: RUTH EURE, 4795 EDISON AVENUE, BOULDER, CO, 80301, US

(21) Appl. No.: 12/657,373

(22) Filed: Jan. 19, 2010

Related U.S. Application Data
(60) Provisional application No. 61/205,463, filed on Jan. 16, 2009.

(51) Int. Cl. C25D 5/00; C25D 11/00; B32B 15/04; B32B 15/01; G11B 5/39; C02F 1/461

(52) U.S. Cl. 428/811.3; 205/317; 205/81; 428/653; 428/652; 428/656; 205/112

(57) ABSTRACT

The present invention provides an alloy film of Mn or its Fe—Mn is depositable on a metalized alumina ceramic (Al₂O₃₋SiO₃) substrate for hermetically sealed glass-metal fusion used for aircraft switch assemblies. The coefficient of thermal expansion of Fe—Mn alloys appear to be fairly low, nearer to that of glass. Fe—Mn alloy film is an alternative to Fe₆₄—Ni₃₆ alloy films (Invar) normally used for glass to glass fusion purposes. Fe—Mn alloy films is also depositable directly on bare Alumina (Al₂O₃) substrate with or without zincating pretreatment. Similarly bright, smooth coherent film of Mn—Au or Fe—Mn—Ni Au alloys is depositable from an aqueous solution of simple salt bath or on Cu substrate without the use of cyanide without bridging with zincate processes.

### CLAIM OF PRIORITY

This patent application claims priority under 35 USC 119(e) (1) from U.S. Provisional Patent Application Ser. No. 61/205,463 filed Jan. 16, 2009, of common inventorship herewith entitled, “Electrodeposition of aluminum and other hard to deposit materials using improved water saving mercy cell.” The contents of the cited provisional patent application are incorporated herein in their entirety by this reference thereto.

### FIELD OF THE INVENTION

The present invention pertains to the field of electrodeposition and more particularly to the field of electrodeposition of hard to deposit materials.

### BACKGROUND OF THE INVENTION

The present invention is an improvement on U.S. Pat. No. 5,965,002, issued Oct. 12, 1999, of common inventorship entitled, “Electrodeposition of manganese and other hard to deposit metals.” The contents of this cited patent are incorporated herein in their entirety by this reference thereto. For clarification purposes, a description of the previously disclosed Mercy cell follows:

Preparation of Electrodes

The anodes were made of low carbon steel and pure manganese flakes cast into a solid rod. The pieces of manganese were not bagged but were successfully melted and cast into short cylindrical rods. The cathode was made of pure copper foil cut into about one centimeter squares. The electrodes were thoroughly prepared as follows: First, the copper foil squares were mechanically sanded with rough and fine emery papers. They were then polished with fine diamond paste on fine linen cloth for about 30 minutes each. The copper foil squares were then rinsed with deionized water, then dilute sulfuric acid, followed by sodium hydroxide, and finally rinsed again with deionzed water. The bare cathodes were then dried and weighed on the balance. They were then lacquered on one side. The cathodes were then reweighed. By subtracting these values, the weight of the lacquer was known and the exact weight of the copper can be monitored. The manganese anodes were cleaned with deionized water, then rinsed with dilute sulfuric acid, followed by a rinse with sodium hydroxide, and finally rinsed again with deionzed water.

Preparation of Electrolyte Solutions

Three solutions were prepared as follows and identified as “C”, “D” and “E”.

Solution C: 11 g/liter manganese sulfate; 30 g/liter iron sulfate; 200 g/liter ammonium sulfate.

Solution D: 150 g/liter manganese sulfate; 195 g/liter iron ammonium sulfate.

Solution E: 60 g/1 manganese sulfate; 30 g/1 iron sulfate; 200 g/1 ammonium sulfate.

Each solution was filtered repeatedly to eliminate precipitated impurities. After preparing the solution, it is allowed to age for at least 24 hours, but must be filtered before use. Not wishing to be bound by any particular theory, it is believed that ions in the new solution are highly mobile and uncontrollable when electricity is applied. When the solution has aged, the mobility of the ions in solution is decreased and the ions are more easily directed to the target cathode when the electricity is applied. Each solution was used to electroplate pure copper foil.

It is important that no soap of any kind contaminate the solutions. It was observed that soap binds to the manganese in solution and prevents deposition on rough or passivated surfaces. This may not be the case for smooth and non-passivated surfaces.

It is important to allow electrodeposits to dry naturally. If they are forced to dry by the application of external heat, the diffusion of manganese into the iron is prevented from taking place resulting in cracking and poor adhesion of the deposit to the substrate.

The Mercy Cell

The Mercy cell is shown in FIG. 1. Turning more specifically to FIG. 1, a PVC cell 20 is about 8.5 cm long, about 8 cm wide. The actual dimensions are not critical to the operation of the invention, but in this case, the cell was designed to hold about 1 gallon of liquid. The cell wall 22 is about 0.5 cm thick and the separating wall 24 is about 1.5 cm thick. Separating wall 24 separates chamber 1 from the other chamber in the cell. The separating wall 24 has a hole 48 in it near the base. Anode 26 is made of iron and anode 28 is made of manganese. Salt solution 30 comprises a simple acid salt including, but not limited to sulfate, chloride or phosphate salts. The cathode 32 is made of copper, either foil or plate. The range of pH of the aqueous solution includes pH 0.45, 1, 2, 3, 4, 5, 6, 7, 8, 9, and 10.5. The power source 34 can be alternating current or direct current. The cylindrical control rod 36 is made of a PVC plastic about 10 cm long and has a hole 38 about 0.2 cm from its base.

In operation, the control rod 36 is rotated so hole 28 in the control rod lines up with hole 38 in the separating wall 24 to allow solution to pass from one chamber to the other thus controlling the rate of migration and diffusion of the most mobile and noble metal ions which tend to deposit at the cathode 32. In addition to electroplating, the cell is about 99.5% effective in separating toxic metal ions from solution to comply with environmental regulatory requirements. The cell is durable, non-magnetic, lightweight and can be modified to any desired volume.

The improvement taught by the present patent application comprises a sensor 50 situated near the cathode 32 for detecting impurities. This sensor comprises copper, nickel, or other combinations of metals having different conductivities. When the solution becomes polluted with conducting ions, the sensor lights up, causing a solenoid valve to open and allow clean water to enter the chamber which contains the solution. When the conductivity of the solution decreases to an acceptable level, the solenoid will close the valve and cut off the flow of clean water into the chamber. This improvement provides for water saving due to water being changed in the chamber only when necessary.

### SUMMARY OF THE INVENTION

It is an object of the present invention to provide Electroless/Electrodeposition of coherent alloy films of binary, ternary, quaternary or an intermediate or near intermediate composition, such as Titanium, Fe—Mn—Ni—Pt, Al—Ni—Au and other hard to deposit metals, for example. These metals are depositable on metal, ceramic, semiconductor, glass or plastic substrate surfaces from simple or complex salt baths of wide pH ranges, using the improved novel electrochemical Mercy Cell.

It is a further object of the present invention to provide an improved Mercy Cell for electrodeposition of hard to deposit metals comprising a sensor for detecting, impurities and means for removing impurities from solution.

It is a further object of the present invention to provide a water saving device for electrodeposition of hard to deposit materials. The improved Mercy Cell comprises a sensor for detecting, impurities and means for removing impurities from solution. This improvement provides for water saving due to water being changed in the chamber only when necessary.

### BRIEF DESCRIPTION OF THE DRAWINGS

FIG. 1 is a diagrammatic representation of the Mercy Cell.

FIG. 1a shows the Hysteresis Loop of Fe—Mn alloy films (1,000 Å).

FIGS. 2 through 13 and 15 through 17 show electron micrographs of coatings made with the improved Mercy cell of the present invention.

FIG. 14 shows a transmission electron micrograph of a coating made with the improved Mercy cell of the present invention.

### DETAILED DESCRIPTION OF THE INVENTION

### Improved Mercy Cell for Removal of Water Contaminants and Improved Water Quality Savings

The improved Mercy Cell comprises a sensor for detecting, impurities and means for removing impurities from solution. The sensor 50 is situated near the cathode 32 for detecting impurities. This sensor comprises copper, nickel, or other combinations of metals having different conductivities. When the solution becomes polluted with conducting ions, the sensor lights up, causing a solenoid valve to open and allow clean water to enter the chamber which contains the solution. When the conductivity of the solution decreases to an acceptable level, the solenoid will close the valve and cut off the flow of clean water into the chamber. This improvement provides for water saving due to water being changed in the chamber only when necessary.

The improved Mercy cell has the potential of being useful for conservation of water for plating rinses and final rinses prior to disposal via the waste water treatment systems. The electrode in the cell construction is made up of inert anodic electrode, Ti or Steel and a conducting metal cathode connected to an external power source. When the electric current is imposed upon the electrodes, the negative terminal of the electrode (cathode) will remove active metal depositing species from the rinse water. In order to remove the organic species in the rinse water, the chamber containing the cathode must be blocked off such that the dissolved organic ions diffuse and adhere on the anodic surface of the electrode to be removed.

The improvement taught by the present patent application comprises a sensor situated near the cathode for detecting impurities. This sensor comprises copper, nickel, or other combinations of metals having different conductivities. When the solution becomes polluted with conducting ions, the sensor lights up, causing a solenoid valve to open and allow clean water to enter the chamber which contains the solution. When the conductivity of the solution decreases to an acceptable level, the solenoid will close the valve and cut off the flow of clean water into the chamber. This improvement provides for water saving due to water being changed in the chamber only when necessary.

It is important that rinse water be approximately neutral pH. pH of 7 to 8 is desirable. If pH is too acidic, then the coating can become brittle; if pH basic, then the coating may exhibit inferior compressive strength.

### Examples

### Electro-Deposition of Fe—Mn—Au or Fe—Ni Alloy Films on Aluminum Substrate from a Simple Salt Bath without the Use Cyanide

The present inventor was the first in 1996, to successfully electrodeposit bright coherent films of Mn, Fe—Mn alloys of intermediate composition or alloys of varying compositions from simple salt bath without the use of cyanide on either a BCC Fe substrate or on fcc Cu substrate (UK GB 1623846.4 and U.S. Pat. No. 5,965,002) patents. It has been found that Fe—Mn alloys are martensitic as well as ductile materials with interesting useful functional properties.

The present invention demonstrates that Mn or its Fe—Mn alloy film is depositable on a metalized alumina ceramic (Al₂O₃— SiO₃) substrate for hermetically sealed glass-metal fusion used for aircraft switch assemblies. The coefficient of thermal expansion of Fe—Mn alloys appear to be fairly low, nearer to that of glass. Fe—Mn alloy film is an alternative to Fe₆₄—Ni₃₆ alloy films (Invar) normally used for glass to glass fusion purposes. Fe—Mn alloy films is also depositable directly on bare Alumina (Al₂O₃) substrate with or without zincating pretreatment. Similarly bright, smooth coherent film of Mn—Au or Fe—Mn—Ni Au alloys is depositable from an aqueous solution of simple salt bath or on Cu substrate without the use of cyanide without bridging with zincate processes.

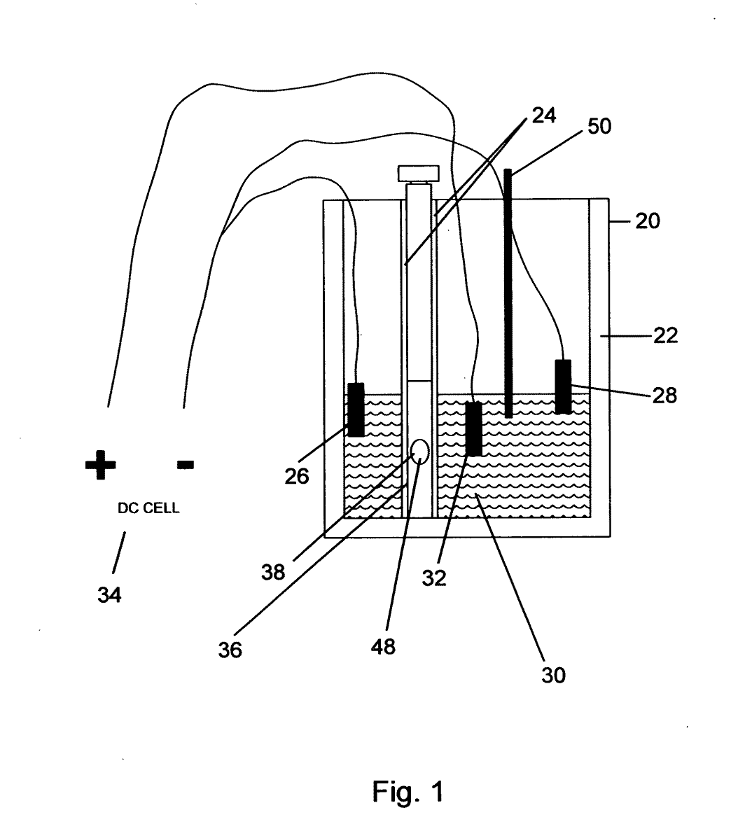

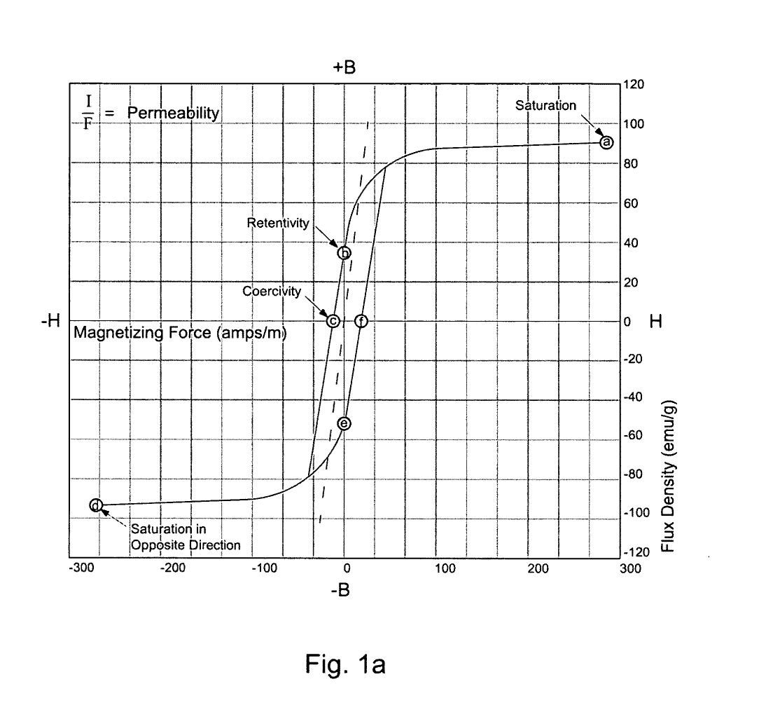

Besides, Fe—Mn or Fe—Ni, Mn—Ni—Au, Fe—Mn—Cr alloy films are respectively soft ferromagnetic material and can be reprocessed with other metal to be come a soft magnetic material (see the alloy hysteresis loop Fe—Mn alloy electro-deposit shown in FIG. 1a). The Mn or its alloy Fe—Mn can be incorporated with thermo-plastic polymeric materials for a secondary rechargeable battery fuel cell electrode manufacture for space craft.

The alloy films of Fe—Mn alloy and its alloys possess gamma ductile bcc, bct, fcc and hcp transformation phases as well as alpha martensitic hard phase. When the Mn is electrodeposited with Fe, they deposited at a single cathodic potential at 1.18 volts vs. SCE form a stable solid solution phase. If the BCC Fe—Mn alloys is deposited on a fcc substrate as on Cu, the alloy is likely to be an fcc phase structure.

The Hysteresis Loop of Fe—Mn alloy films (1,000 Å) is shown in FIG. 1a shows magnetic properties of Fe—Mn alloy films. The magnetization of coherent ultra thin films of Fe—Mn alloy will be demonstrated.

In thermal processing of Fe—Mn alloys are antiferomagnetic materials while those depositing from aqueous solution of simple bath is ferromagnetic material. Much information can be obtained about the magnetic properties of a material by studying its hysteresis loop. The hysteresis loop shown demonstrates the relationship between the induced magnetic particle density and the magnetizing force field (the applied electrical current).

The FIG. 1a shows Fe—Mn alloy thin film magnetization hysteresis curve. The films is hysterestic because usually when a force is applied the applied field shifts and rotates the magnetic domains in a ferromagnetic material such that the volume of domains aligned with the applied field grows. Once the domain alignment with the increase is completed, there can be no further increase in the applied field to increase in domain alignment upward in the M direction and so saturation point is reached as seen in the curve. If the electrical current is then set back to zero, the magnetization failed to follow the original curve but lags behind. This phenomenon is hysteresis. The alloy film was examined under the TEM, XRD and SEM determined that the processing temperature determined the surface darkness of the alloy films and the at wt % Mn in the alloy films composition. The effect of the bath's pH also determined the wt % Mn in the alloy films, the microstructures of the alloy films as well as whether the electro-deposition occurs or not on the substrate. The samples were selected randomly and analyzed for magnetic properties. The size and shape of the hysteresis loop of the alloy deposits analyzed confirmed that the alloy film possesses soft magnetic properties. The alloy magnetic on the above graph shows the area where the magnetic domains are completely aligned such that any increase in the magnetizing force field would provide very minor increase in magnetic flux. At this point slightly above the 80 gauss, the material had reached the point known as magnetic “saturation”. When the magnetic force field was reduced to zero, the curve moved from its right most top point (+“H”) backward to the middle or center of the hysteresis loop of the curve (+B). At this point “+B” some remnant of magnetic flux remained still in the material. This is known as point of magnetic flux retentivity (remanence) or point of residual magnetism where partial magnetic domains remained aligned in the materials although some have not. When the magnetic force field is reversed down the +Y plane toward the zero X axis the value of the magnetic flux was reduced to zero value. At this point where the value of the magnetic flux at zero X axis is known as point of coercivity on the curve. Here the net magnetic flux in the material is zero. Here the force needed to remove the residual magnetism from the material is known as the coercive force or coercivity of the material. Accordingly, as the magnetizing force is increased in the negative (below −x) direction, the material will again become magnetically saturated but in the opposite direction (point+y). Reducing H to zero brings the curve to point “e.” It will have a level of residual magnetism equal to that achieved in the other direction. Increasing H back in the positive direction will return B to zero. Notice that the curve did not return to the origin of the graph because some force is required to remove the residual magnetism. The curve will take a different path from point “f” back to the saturation point where it with complete the loop.

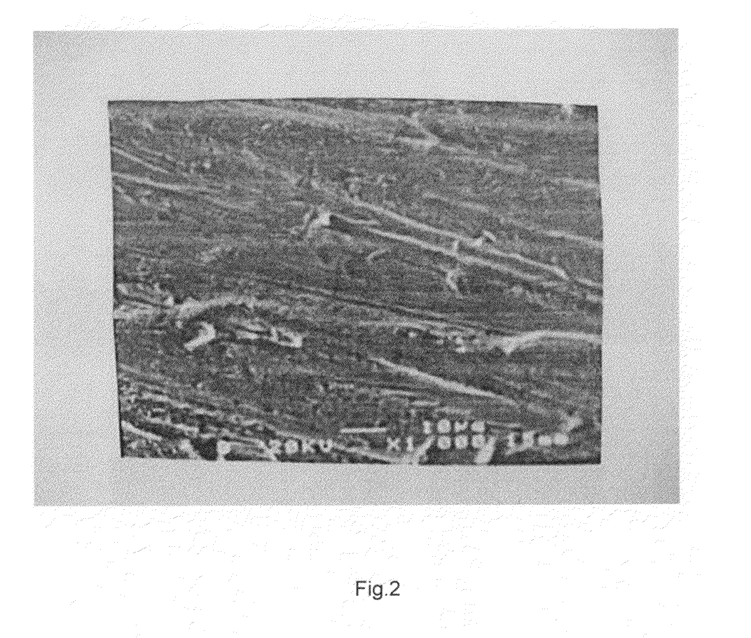

FIG. 2 shows a SEM photomicrograph of amorphous films of Fe—Mn alloys ever shown and reported. The alloy films containing 6 at wt % Mn and 94 at wt % Fe was electrodeposited from an aqueous solution of simple salt at 25° C., pH 0.5 in 15 minutes.

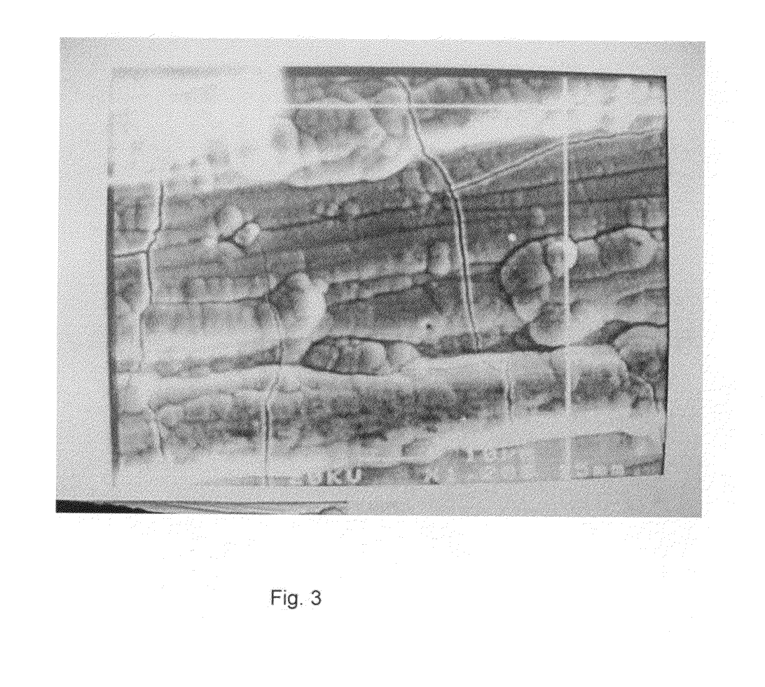

FIG. 3 shows a SEM of Fe—Mn alloy films deposit from a simple salt bath at 25° C., 872 Ma/cm², pH2.5 in 12 minutes. The films shows clusters of atoms of Mn atoms forming columnar clusters on a Cu fcc crystal lattice as Fe—Mn (Cu₁₁₁) alloy films. The alloy thick films about 25 microns contain 20 at wt % Mn and 21 at wt % Fe. The rest are made up of Cu.

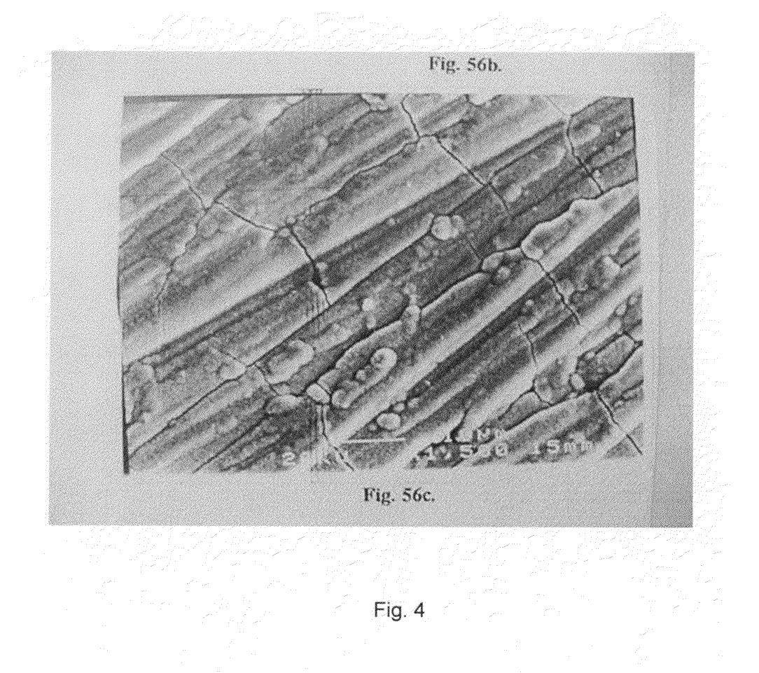

FIG. 4 shows a SEM of Fe—Mn coulumnar/equiax film mixture of structures deposited from bath at pH6, showing columnar grain structure. Courtesy photomicrograph from Udofot's Postgraduate work at The University of Birmingham, Edgbaston, Birmingham, England.

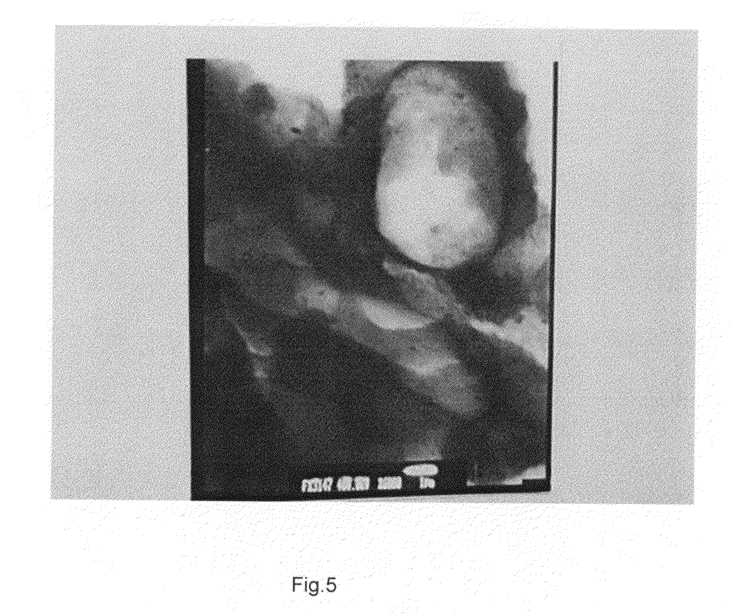

FIG. 5 shows SEM dark film of Fe—Mn alloy films deposited from aqueous solution of simple pH1 bath. The ultra thin films of Fe—Mn alloy films was peeled off Cu substrate upon which it was deposited on. The film shows the presence of bright cylindrical Fe film co-deposition with the dark appearing Mn film to form an alloy of Fe—Mn single solution film. Courtesy photomicrograph from Udofot's Postgraduate work at The University of Birmingham, Edgbaston, Birmingham, England.

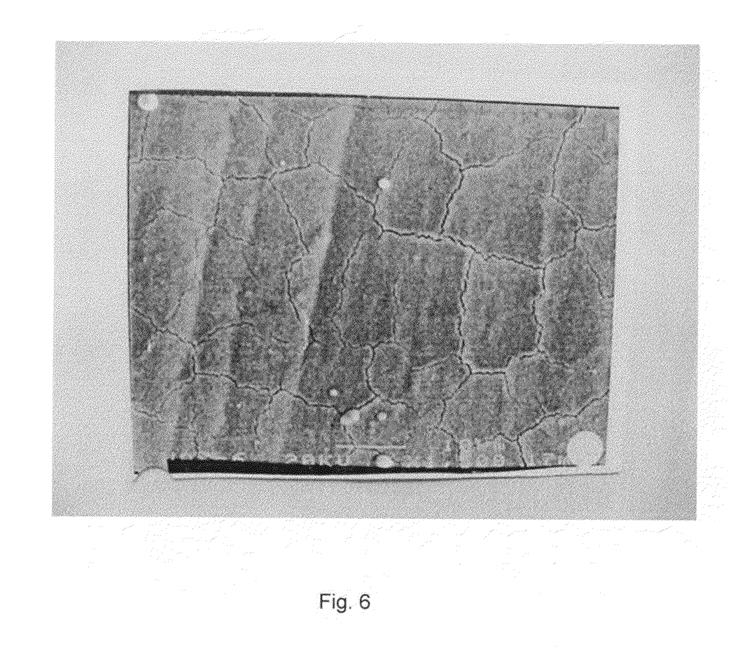

FIG. 6 shows SEM photomicrograph of Fe—Mn alloy films showing equiax grain structure. The alloy of Fe—Mn structure was observed when the film was deposited from bath at pH1.8, 25° C. in 20 minutes. The photomicrograph was processed at the School of Metallurgy & Materials Engineering Department, at the University of Birmingham, Edgbaston, Birmingham, England. Courtesy photomicrograph from Udofot's Postgraduate work at The University of Birmingham, Edgbaston, Birmingham, England.

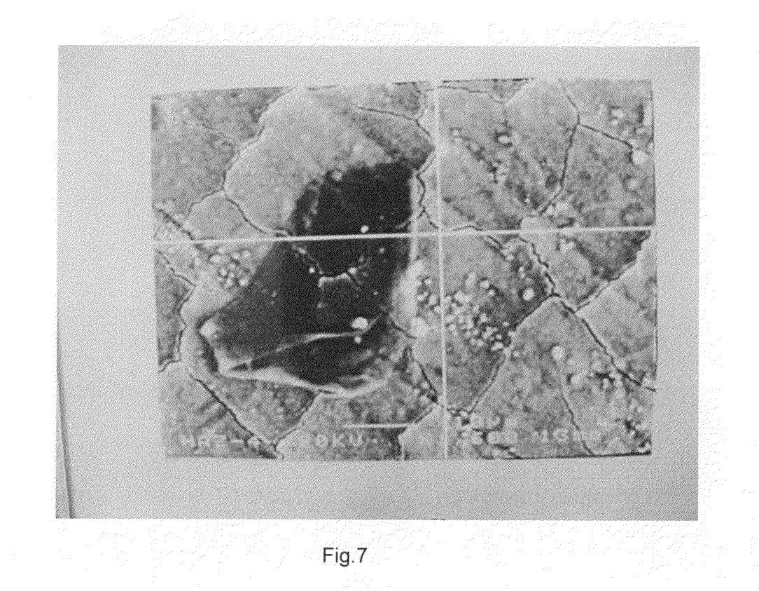

FIG. 7 shows SEM of Fe—Mn equiax bcc alloy films deposited on Cu substrate from bath of low pH2. The films surface shows evidence of fine oxide on the surface areas where hydrogen dissolved. The about Feₐᵣ —Mn₄₀ alloy films. Courtesy photomicrograph from Udofot's Postgraduate work at The University of Birmingham, Edgbaston, Birmingham, England.

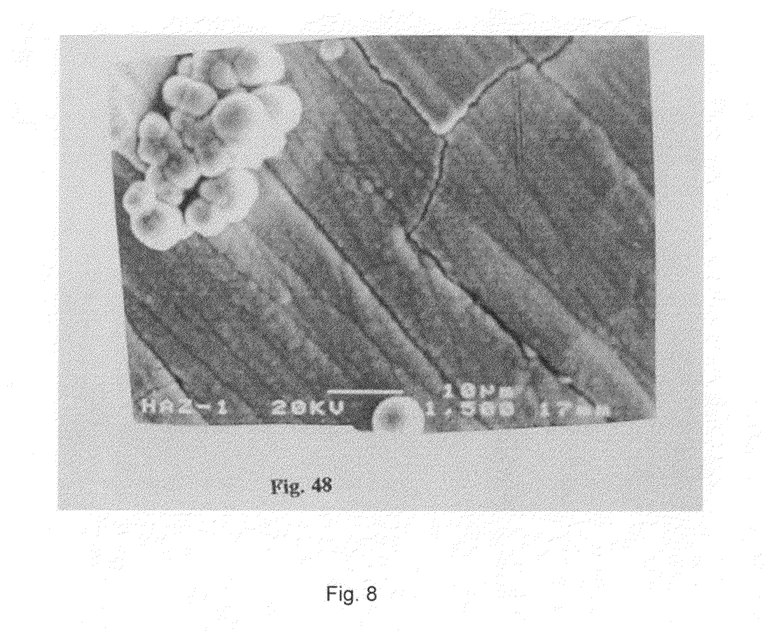

FIG. 8 shows SEM photomicrograph of lamellar Fe—Mn alloys films deposited from bath at pH7. The films contains satellites of oxide film codeposition on the alloy film with capacity to cause the alloy films to be hard and brittle. Courtesy photomicrograph from Udofot's Postgraduate work at The University of Birmingham, Edgbaston, Birmingham, England.

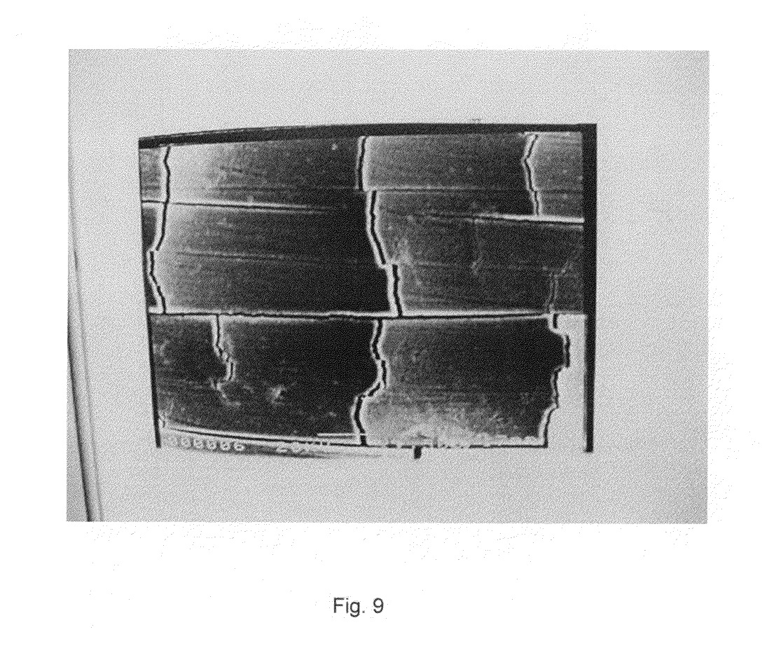

FIG. 9 shows SEM photomicrograph of Fe—Mn alloy films showing a lamellar film growth mode structure deposited on Cu substrate as Fe—Mn (Cu 111). The film structure was observed when the film was deposited from bath at pH1 in 15 minutes processing time. The unusual plate like structures are seen in FIG. 9. The Fe—Mn alloy films contain about 13 at wt % Mn.

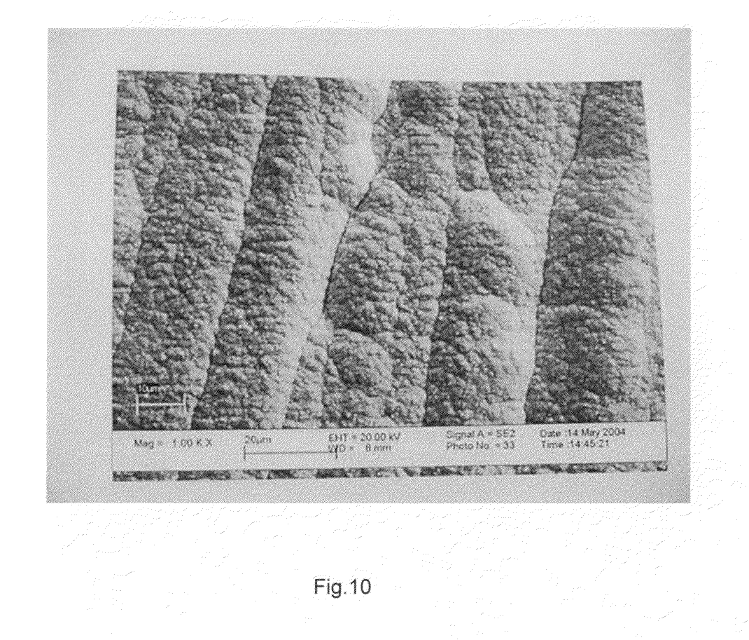

FIG. 10 shows The above SEM photomicrograph shows columnar single crystalline structure of Ni nanoclusters (film) deposited on single Cu₁₁₁ zone axis to form in 3 minutes a Ni₁₀₀(Cu₁₁₁) single solid phase FCC structure from a simple water bath of pH2 at room temperature.

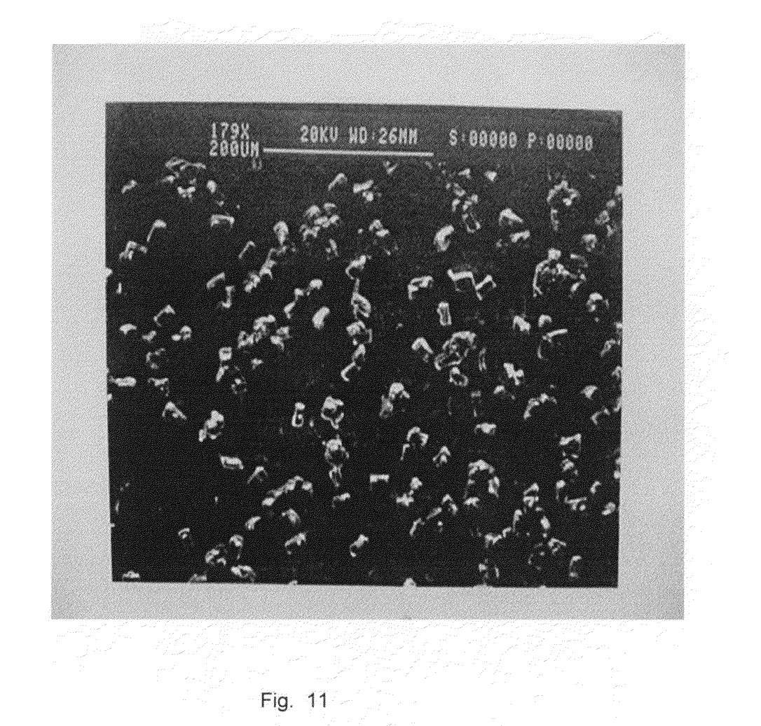

FIG. 11 shows SEM photomicrograph shows equiax cubical crystal structure of Fe—MnP deposited on single Cu 111 zone axis in about 1 minute from bath of pH1 at 50° C.

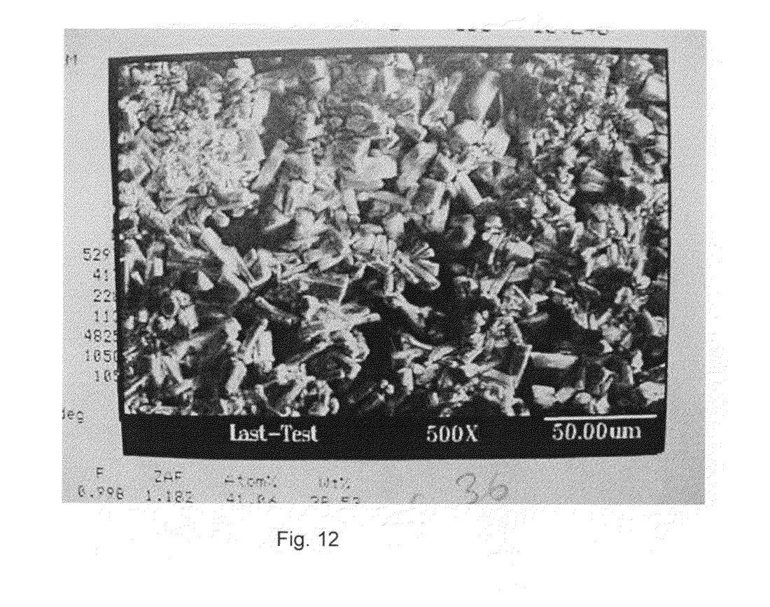

FIG. 12 shows The above SEM photomicrograph shows equiax cubical crystal structure of Fe—MnP nanoclusters (film) deposited on single Cu 111 zone axis in 5 minutes to form alloy composition of a Fe₂₀—Mn₅₀—P₃₀(Fe₁₀₀) single solid phase bcc structure from bath of pH2 at 50° C. The inorganic phosphate co-deposited is restricted to the Fe—Mn alloys to nano-cubidal structure being inhibited from further crystal growth to broader microstructure size formation.

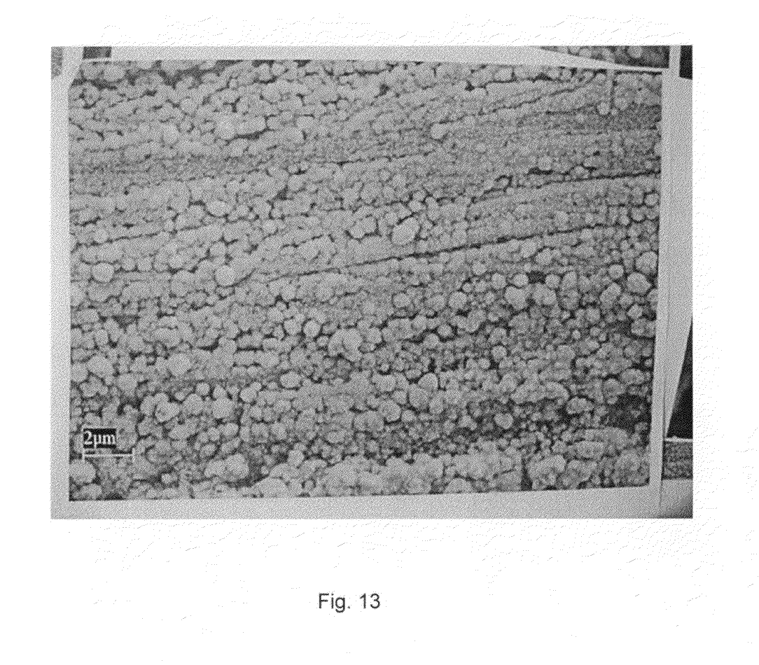

FIG. 13 shows The above SEM photomicrograph shows equiax nano crystalline polycrystalline structure of Ni—Fe supper films deposited on single crystal Cu₁₁₁ zone axis to form in 3 minutes a Ni₄₀ —Fe₃₀ (Cu₁₁₁) single solid phase bcc structure from a bath of pH2 at room temperature.

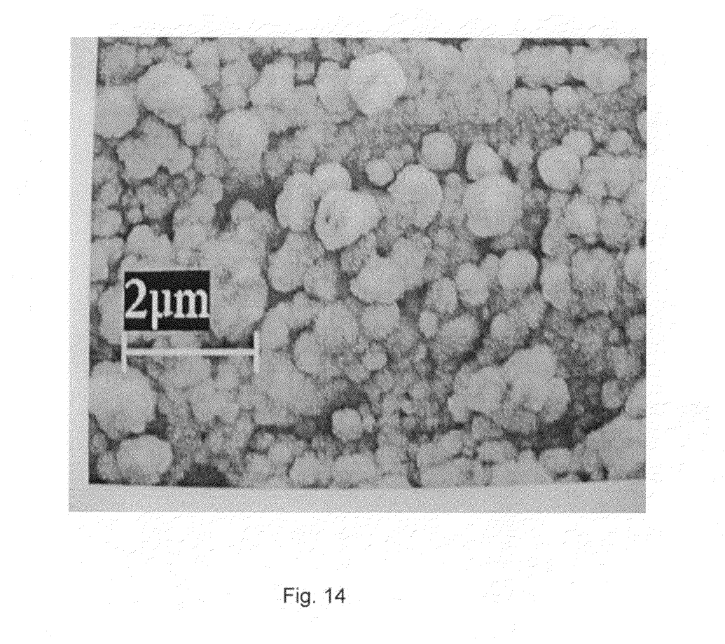

FIG. 14 shows Transmission electron micrograph showing clusters of spheriodal y′ prime nano-particles of Fe—Ni superalloy deposits in Cu matrixes (crystal lattice or lattice parameter). The alloy was electrodeposited from a simple water bath at pH1, 25 deg. C. in 3 minutes.

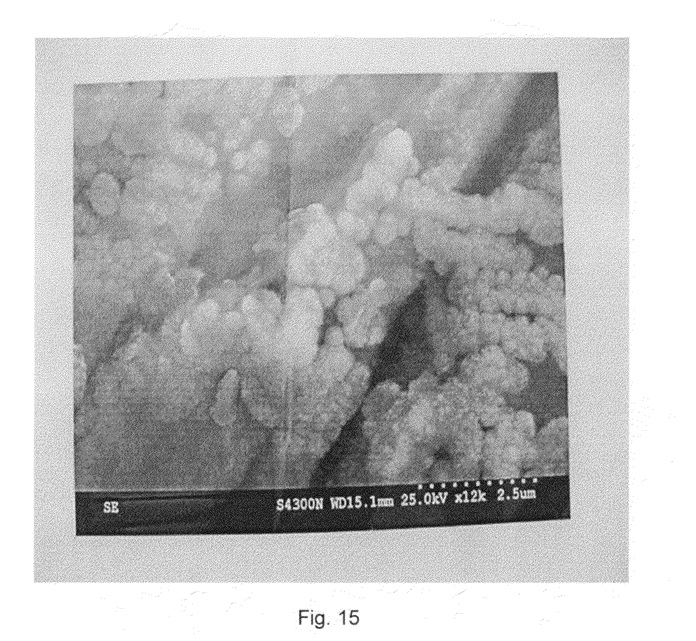

FIG. 15 shows SEM photomicrograph of Ni single crystal electrodeposited from a water bath containing sacrine additive. The nano deposit of Ni shows the Ni FCC films deposit on FCC Cu 111 substrate different from the one above that was deposited from the watt bath that did not contain sacrine.

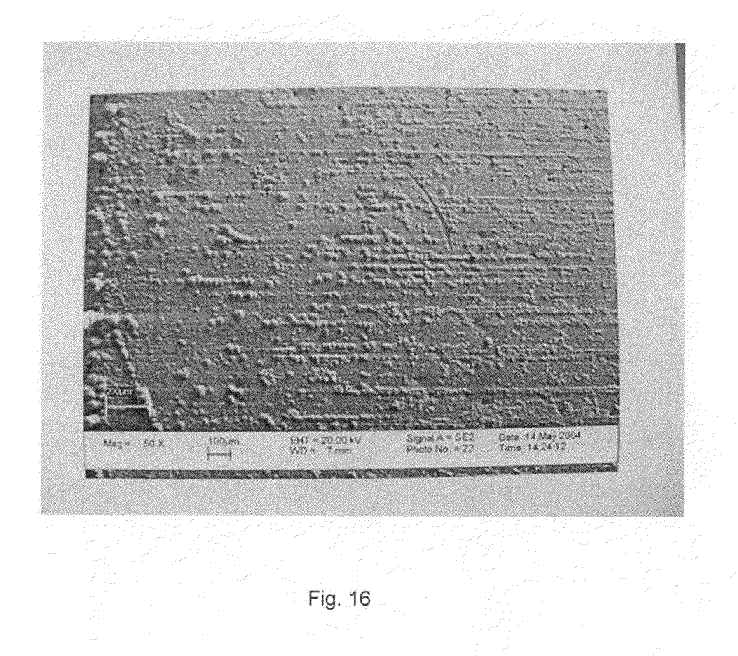

FIG. 16 shows SEM photomicrograph shows columnar crystal structure of Ni nano film, deposited on single Cu₁₁₁ zone axis to form in minute a Ni₁₀₀(Cu₁₁₁) single solid phase FCC structure from a bath of pH0.5 at room temperature. The films were observed to deposit on site where the hydrogen bubbles escaped.

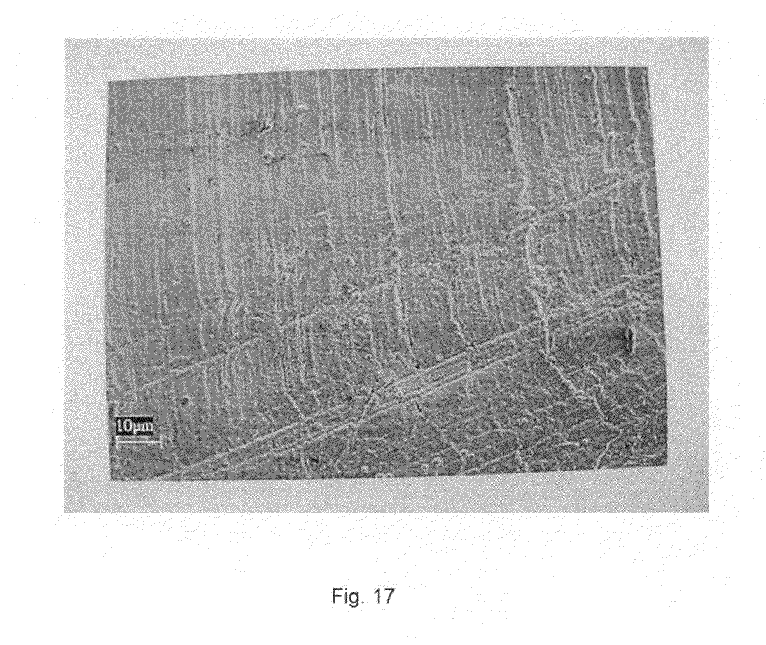

FIG. 17 shows SEM photomicrograph of Ni amorphous film was electro-deposited on single Cu zone axis to form in smooth Ni₁₀₀(Cu₁₁₁) single solid phase FCC structure from a bath of pH0.5 processed at room temperature. The films were observed to deposit on the center cu plate where the substrate surface energy was lower than at the corner Cu surface.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A method of removing total dissolved solids (TDS) contaminants from disposable rinse water and depositing TDS onto an electrode substrate comprising the steps of:
a) placing a passive inert metal anode into a first chamber of an electrochemical cell having at least two chambers and wherein the cell contains a de-ionized or non-de-ionized rinsing solution wherein the total dissolved solids is selected from the group consisting of acids, alkaline, and chlorides;
b) placing an inert metal-containing anode into a second chamber of the electrochemical cell;
c) passing electricity through the electrochemical cell for a time sufficient to cause deposition of TDS comprising impure metal organics, and inorganics to deposit onto the electrodes;
d) allowing the deposition to continue until the desired amount of contaminant deposition is achieved;
e) stopping the flow of electricity; and
f) removing the electrode which has been deposited with the TDS impurities from the contaminated rinse water.

2. The method of claim 1 further comprising:
g) testing the final rinse water to determine conductivity or resistivity level by inserting a water meter sensor connected to an external electrical power source by placing the water meter sensor into the rinse water in the cell and set the conductivity range appropriate for tap water or de-ionized water to observe its usability; and
h) repeating steps b) through f) until water is no longer conductive.

3. An amorphosus, nanocrystalline, microstructural, equiax, lamellar crystal structure, microstructural, single, polycrystalline, thin, ultra thin, or thick film of Fe—Mn, coherent bright electrodeposits of (a) Mn, Ni, and its alloys (Fe—Mn, Fe—Mn—Au, Mn—Ni—Au, Fe—Ni—Mn, Fe—Mn—Au, Fe—Mn—V) on a substrate selected from the group consisting of: Al2—, Al—Mn—MO, Ti, and Steel, wherein the film comprises one or more of the following characteristics:
a. the film is bright, dark, and coherent on the substrate;
b. the film electrodeposited is made up of a single crystal deposited structure, alloys of any Mn or Nickel, gold or Vanadium composition or intermediate composition;
c. the film is deposited on activated ceramic alumina substrate and superconducting metal joint by use of filler metal suitable for brazing for hermetically sealed sensor assemblies applications;
d. the film is depositable on superconducting tubes or pins and fused to glass ceramic such as alumina silica or borosilica suitable for use in hermetically sealed switch assemblies;
e. the film has soft magnetic or hard magnetic properties;
f. the film is depositable from ranges of temperatures from about 3 through 100 degrees Celsius or higher;
g. the film comprises electrodeposition of hard to deposit metals, such as Vanadium, gold, on Ti or Al, Fe—Mn, Fe—NiCr, Fe—MnP, Fe—Mn—MO, Fe—Mn—Ni, Fe, Cu, and W substrate respectively without the use of cyanide or selenium;
h. the film comprises electrodeposition of Mn, alloys such as Fe—Mn, Fe—MnCO, possessing soft or hard magnetic properties having wide ranges of hysteresis loop and interesting useful properties suitable for MEMS, micro relays, giant magneto resistive head manufacturing; magnetic shielding and X-radiation shielding applications;
i. the film comprises electrodeposition of Mn, Fe—Mn having similar properties as Fe—Ni (invar), having low thermal coefficient of thermal expansion and low coefficient of friction useful for glass to metal fusion or metal to ceramic insulator joining;
j. the film comprises electrodeposition of bright coherent Fe—Mn and
Fe—Ni of intermediate composition or Mn and Ni at wt % Composition having various crystal microstructures from a simple salt bath ranging from about pH 3 through pH11.5, temperatures-14 through 100 deg. C. and above, for various aerospace, automotive, electronics and MEMS applications.

4. The method of claim 1 used to deposit soft ferromagnetic or antiferromagnetic alloy films for thermal shielding, radiation barrier shielding and or magnetic shielding applications.

5. The method of claim 1, incorporating the Mn, Ni, or its alloy films with alloy polymeric material for secondary rechargeable battery fuel cell porous electrode fabrication.

6. The method of claim 1 useful for improved water purification use and conservation.
